(19) United States
(12) Patent Application Publication
(10) Pub. No.: US 2010/0162910 A1
(43) Pub. Date: Jul. 1, 2010

(54) Device for mounting and angular adjustment of cliches

(76) Inventors: Torben Malm, Vintrosa (SE); Gösta Mühlbach, Orebro (SE)

Correspondence Address: HARNESS, DICKEY & PIERCE, P.L.C., P.O. BOX 8910, RESTON, VA, 20195, US

(21) Appl. No.: 12/448,357

(22) PCT Filed: Nov. 30, 2007
(86) PCT No.: PCT/SE2007/001063

§ 371 Date: Feb. 12, 2010

(30) Foreign Application Priority Data
Dec. 18, 2006 (SE) 0602709-8

(51) Int. Cl. B41F 27/06

(52) U.S. Cl. 101/383

(57) ABSTRACT

A device for tensioning and angularly adjusting a printing plate mount (4) on a rotary printing cylinder (5) having a duct (11), which is formed in the longitudinal direction (9) of the printing cylinder and in the outer surface thereof and in which the device is mounted. The device comprises a base plate (38) on which a pair of fastening profiles (6, 7) for holding the printing plate mount (4) are movably arranged, a pair of guide pins (14) engaging a pair of shoulders (15) for angularly adjusting one fastening profile (6) when moving the guide pins (14) or the shoulders (15) in the longitudinal direction (9) of the printing cylinder (5). The two fastening profiles (6, 7) are connected to one another through a linkage (19), which converts the angular adjustment of one fastening profile (6) to a longitudinal displacement of the other fastening profile (7).

The present invention relates to a device for tensioning and angularly adjusting clichés or printing plates on a rotary printing cylinder having a duct, which is formed in the longitudinal direction of the printing cylinder and in the outer surface thereof and in which the device is mounted, the device comprising a base plate on which a pair of fastening profiles for holding the printing plates are movably arranged, a pair of guide pins engaging a pair of shoulders for angularly adjusting one fastening profile when moving the guide pins or the shoulders in the longitudinal direction of the printing cylinder and the two fastening profiles being connected to one another.

More particularly, the invention concerns rapid replacement of clichés on printing cylinders and angular adjustment of the clichés thereon without the need to remove them from the printing cylinder.

Printing on corrugated board takes place in a so-called flexographic printing process. Flexible clichés are used. These clichés are mounted on a mounting foil in such positions relative to one another as to correspond to the relative positions of the various printed images on, for example, a corrugated board box to be manufactured. The mounting foil with the mounted printing plates is attached to the printing cylinder of the printing unit by winding it around the printing cylinder and is secured to the printing cylinder by an attachment strip at the leading edge and rubber straps with hooks at the trailing edge being hooked onto a front fastening profile and a rear fastening profile of the printing cylinder.

It is desirable to be able to adjust the position of the printed image both in the direction of operation of the machine and perpendicular to the direction of operation of the machine. In modern printing units for corrugated board, such adjustments are completely motorized and computerized. Moreover, in the case of very exacting requirements for, for example, matching print between different colours, it is necessary to be able to make fine adjustments of the angle of the printed image. This is time-consuming and difficult, since the mounting foil may have to be dismounted and readjusted.

In modern manufacture of corrugated board boxes, use is made of so-called in-line machines, rotary die cutters with printing units and separate printing machines. These are high-output machines and the production is characterized by corrugated board boxes and other corrugated board packing of various formats, properties and appearance being produced in consecutive series. This constantly varying production results in corrugated board products of all kinds, differing in size, appearance and properties. To meet the demands of modern production, machine requirements are exacting. The tendency within the industry is shorter and shorter series of boxes and other corrugated board packing. Orders for a few thousand products of the same kind have become the norm. Due to the high production rate of the machines, the batches are finished very quickly and the machine has to be set for the next series of boxes at short intervals. This means that reducing the set-up times between the batches being produced is very important to obtain a high output. To reduce the set-up times, the setting operations of in-line machines have been motorized and automated. Time-consuming, manual machine-setting operations have been replaced by automatic systems.

However, manual work in the machines is still required when changing production from one batch of boxes to another. Replacing the clichés to obtain different printed images or text on the various series of corrugated board products requires manual work. In recent years, it has become increasingly important to simplify this work and reduce the time required, since corrugated board products are increasingly provided with printed images and text. Multicolour printing is used more often. By simplifying the handling and reducing the time required when replacing printing plates, or rather printing plate mounts with mounted printing plates, a further step is taken to reduce the machine set-up times. This is an important measure to increase machine output.

EP 0972639 discloses a device for adjusting the position of a flexible printing plate on a plate cylinder. The device is operated by laterally displacing the plate cylinder a certain distance by means of an external actuating means and an annular cam outside the plate cylinder. A roller bears on the inner edges of the cam and is secured to a base plate, which is freely movable in a groove in the plate cylinder and supports a pair of mutually parallel claws. Two cams are fixedly attached to the bottom of the groove in the plate cylinder and control the movement of two rollers connected to the base plate in an opposed, sloping and parallel movement. A complex pneumatic-mechanic system is integrated in the plate cylinder for actuating the device.

Compared with this known device, the device according to the invention offers a simplified technical solution, lower manufacturing costs and increased reliability. Furthermore, the actuating mechanism according to the invention requires less space in the printing cylinder, which affords better conditions for balancing the printing roller, something that is of great importance as regards the printing cylinder.

An object of the invention is, therefore, to provide a device for tensioning and angularly adjusting printing plates on a printing cylinder, which is relatively inexpensive to manufacture and reliable in service.

A further object of the invention is to provide a device for tensioning and angularly adjusting printing plates on a printing cylinder, which is easy to operate and which allows the printing plates to be easily and rapidly replaced.

A still further object of the invention is to provide a device for tensioning and angularly adjusting printing plates on a printing cylinder, which is of low weight and affords satisfactory conditions for balancing the printing cylinder.

These objects are achieved by a device according to the invention, which is characterized in that the base plate is fixedly attached in the duct and has a groove, which extends in the longitudinal direction of the printing cylinder and in which a bar that supports the guide pins or shoulders is movably carried, that the front fastening profile is pivoted on a centre pin, which is fixedly attached to the base plate, and comprises said shoulders or guide pins, that the rear fastening profile is movably carried on the base plate, substantially in the direction of rotation of the printing cylinder and that the fastening profiles are connected to one another through a linkage at one end wall of the printing cylinder.

Further developments of the device according to the invention appear from the features stated in the dependent claims.

Preferred embodiments of the invention will be described below by way of example, reference being made to the accompanying drawings, in which:

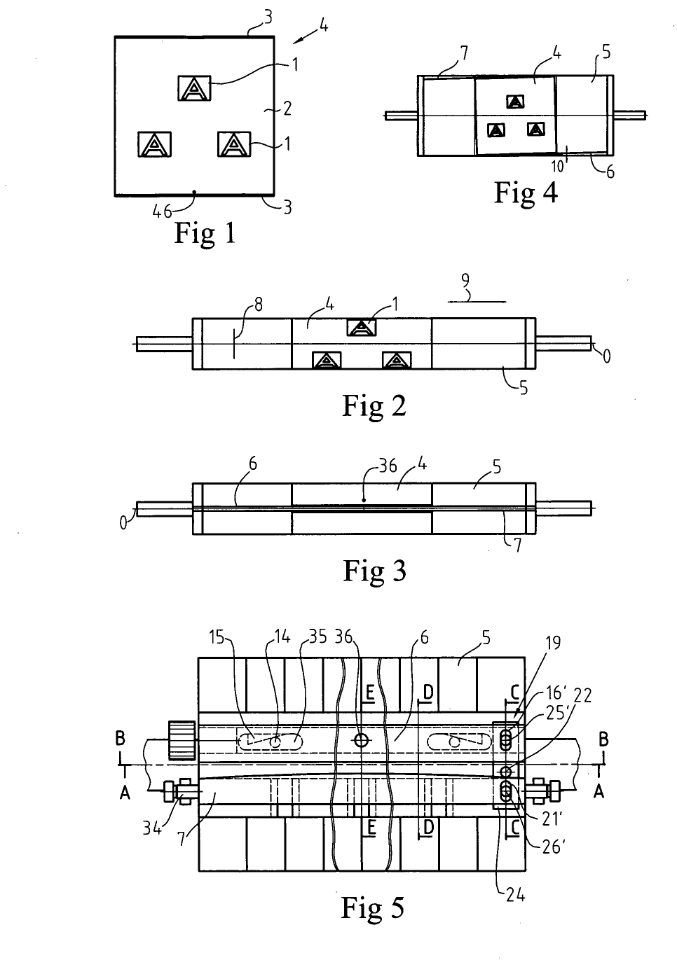

FIG. 1 is a plan view of a printing plate mount;

FIG. 2 is a top view of the printing plate mount in FIG. 1 as mounted on a printing cylinder;

FIG. 3 is a bottom view of the printing plate mount as mounted on the printing cylinder;

FIG. 4 illustrates an angular adjustment of the printing plate mount;

FIG. 5 is a view corresponding to that of FIG. 3, which illustrates the structural parts of the device according to the invention;

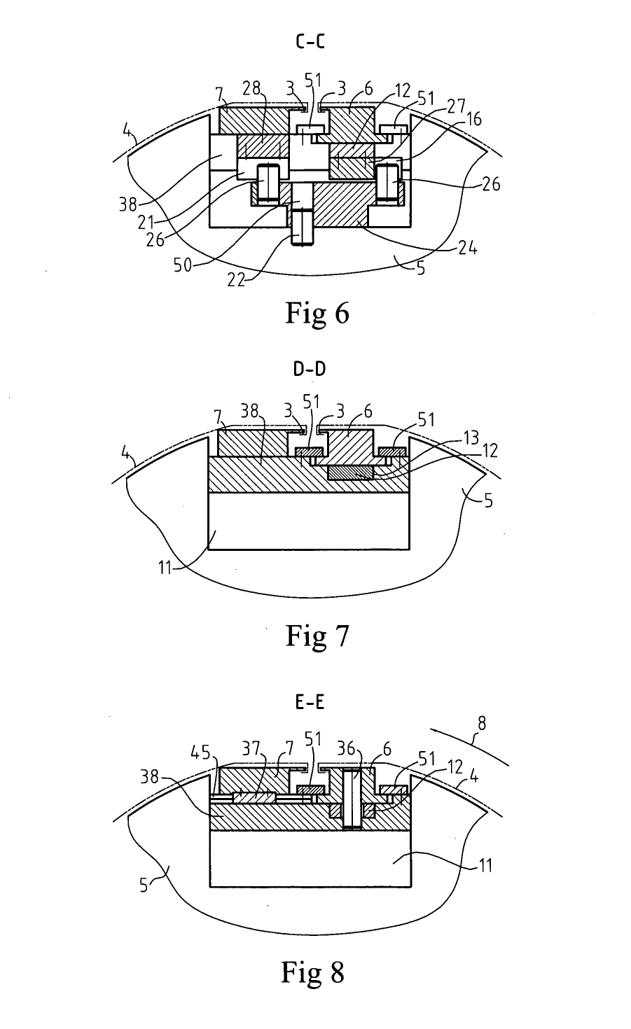

FIG. 6 is a view along the section C-C in FIG. 5 of the structure of the device and, in particular, of an embodiment of its connecting mechanism or linkage;

FIG. 7 is a view along the section D-D in FIG. 5 of the fastening profiles, the adjusting bar and the base plate;

FIG. 8 is a view along the section E-E in FIG. 5 of the centre pin, the rear fastening profile and its profile mouldings;

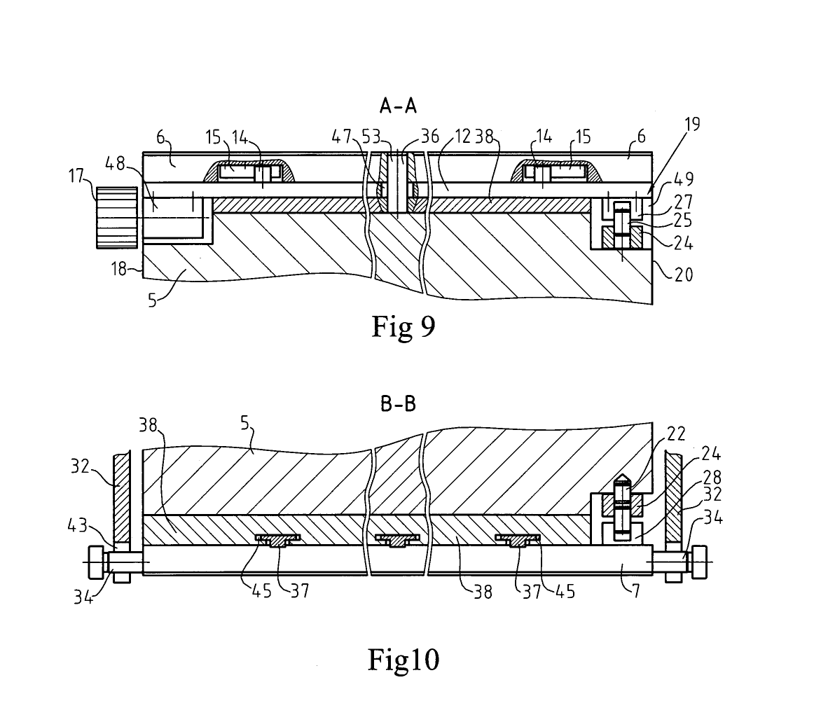

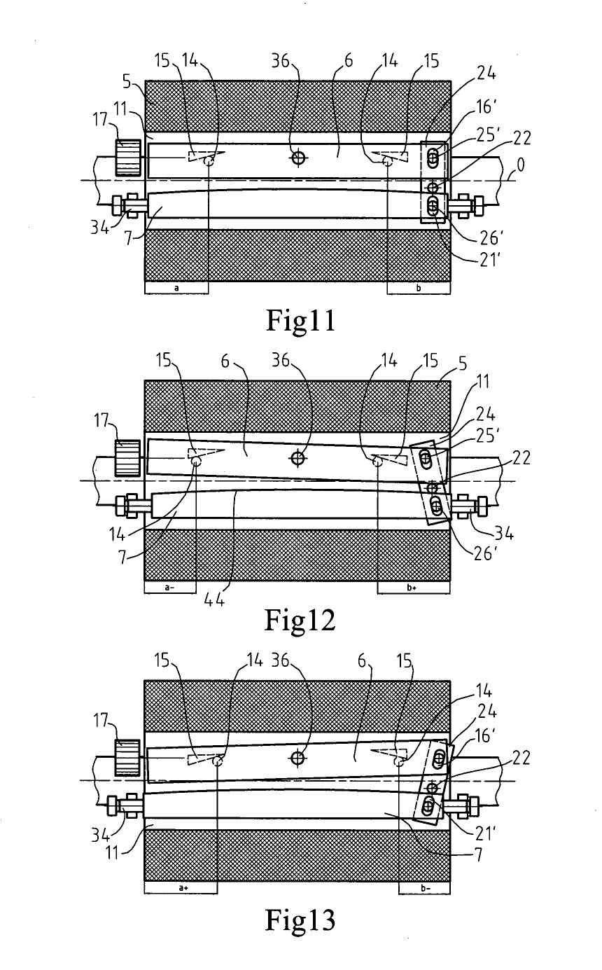

FIG. 9 is a sectional view substantially along the line A-A in FIG. 5 of the connection between the adjusting bar and the front fastening profile;

FIG. 10 is a view along the section B-B in FIG. 5 of the rear fastening profile and its profile mouldings;

FIG. 11 is a schematic view of the fastening profiles in their neutral position, i.e. no angular adjustment of the printing plate mount;

FIG. 12 is a view similar to that of FIG. 11, which illustrates the fastening profiles in a position of angular adjustment of the printing plate mount to one side;

FIG. 13 is a view similar to that of FIG. 11, which illustrates the fastening profiles in a position of angular adjustment of the printing plate mount to the other side;

FIG. 14 is a view similar to that of FIG. 3, which shows supplementary means for securing the printing plate mount to the printing cylinder;

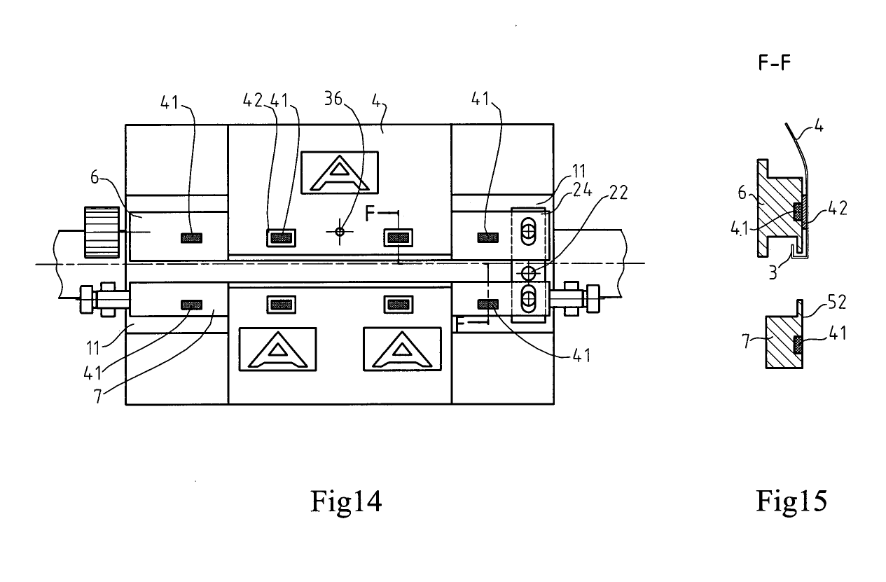

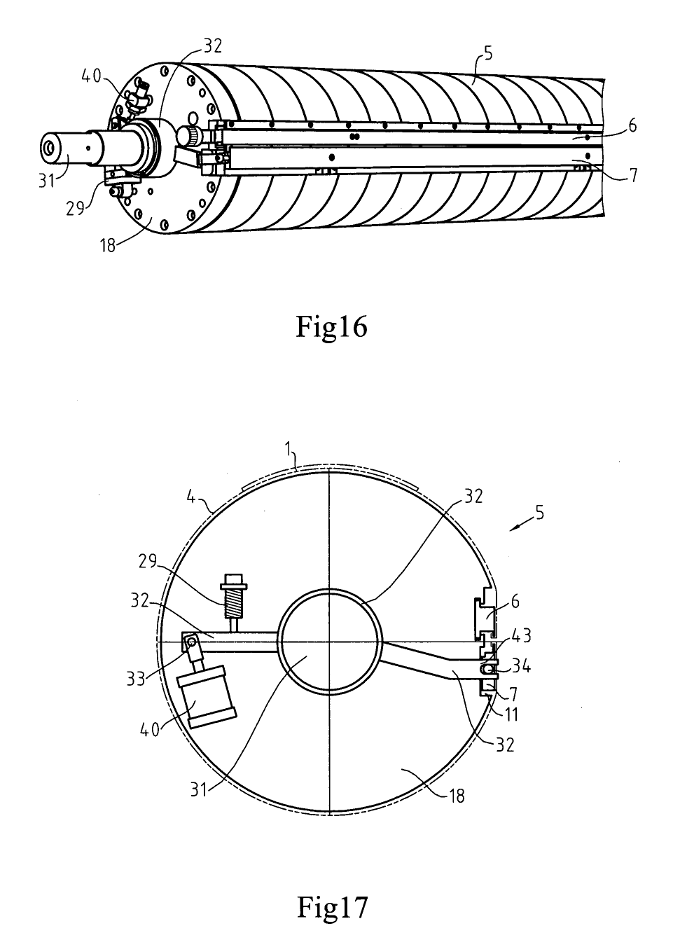

FIG. 15 is a schematic view along the section F-F in FIG. 14 of the fixing/securing means for the printing plate mount;

FIG. 16 is a partial perspective view of the mechanism for tensioning the printing plate mount; and

FIG. 17 is an end view, on an enlarged scale, visualizing the functioning of the mechanism in FIG. 16.

Reference is first made to FIG. 1, which shows a number of flexible printing plate 1 for use in the printing of images and text on corrugated board sheets and the like, for example sheets that are to be used as boxes. The printing plates are mounted on a mounting foil 2 in such positions relative to one another as to correspond to the relative positions of the various printed images or texts on the corrugated board sheet and the like. The mounting foil 2 is provided with attachment strips 3 at the leading edge and the trailing edge thereof, as seen in the direction of rotation 8 of the printing cylinder 5. The mounting foil 2 with its mounted printing plates 1 and attachment strips 3 is called a printing plate mount 4 and is mounted on the printing cylinder 5 by winding it around said cylinder. The printing plate mount is attached to the printing cylinder by hooking the attachment strips 3 onto a front fastening profile 6 and a rear fastening profile of the printing cylinder 5, see FIGS. 2, 3 and 17.

It is desirable to be able to adjust the position of the printed image both in the direction of rotation 8 of the printing cylinder 5 and in the longitudinal direction 9 of the printing cylinder. In modern printing units for corrugated board, such adjustments are completely motorized and computerized. Moreover, in the case of very exacting requirements for, for example, matching print between different colours, it is necessary to be able to make fine adjustments of the angle of the printed image. This is time-consuming and difficult, since the printing plate mount 4 may have to be removed and readjusted.

The invention concerns certain operations in a device, which allow angular adjustment of the printed image without removing the printing plate mount from the printing cylinder.

The present invention concerns a device that causes a lateral displacement of the rear edge of the printing plate mount 4, i.e. the attachment strip 3 that is attached to the rear fastening profile 7. Such a lateral displacement is a prerequisite to achieving an angular adjustment 10 of the printing plate mount 4, see FIG. 4, and is a direct geometric consequence of the angle of the front edge, i.e. the front fastening profile 3, being altered.

Referring now to FIGS. 5-10, the structural elements of the angular adjustment mechanism of the device will be explained in greater detail.

In the printing cylinder 5 and in its outer surface, a duct or groove 11 is provided, which extends in the longitudinal direction 9 of the printing cylinder. In said duct, a base plate 38 is rigidly secured to the bottom of the duct 11 (see FIG. 9) or, alternatively, at a certain distance from the duct bottom (see FIGS. 7 and 8). The base plate 38 has a groove 13 which extends in the longitudinal direction 9 of the printing cylinder and in which an adjusting bar 12 is movably carried in its longitudinal direction (or the longitudinal direction of the printing cylinder), see FIGS. 7 and 9. Projecting from the adjusting bar towards the outer surface of the printing cylinder 5 is a pair of guide pins 14, which are fixedly attached each to one side of an opening 47 in the centre of the adjusting bar 12, see FIG. 9. A screw mechanism 48 is mounted at one end of the adjusting bar and is actuated by means of a knob 17 located at one end wall 18 of the printing cylinder. These can be used to position the adjusting bar 12, and thereby the guide pins 14, in the longitudinal direction 9 of the printing cylinder, for reasons that will be explained below.

A centre pin 36 is fixedly attached to the bottom of the duct 11 and extends radially from said bottom, through a bore in the base plate 38 and with a play through the opening 47 in the adjusting bar 12 to, or past, the outer surface of the printing cylinder 5. The centre pin 36 is located substantially right between the end walls 18, 20 of the printing cylinder and the front fastening profile 6 is pivoted thereon, supported by the adjusting bar 12. In the central portion of the fastening profile there is a bore 53 through which the centre pin 36 extends and on both sides of the bore 53 an oblong hole 35 is formed in the fastening profile 6, said holes 35 each having a shoulder or cam 15, which are mirror-inverted relative to one another, see FIG. 5. The respective guide pins 14 of the adjusting bar extend through the holes 35 and engage the associated shoulder 15.

At the other end of the adjusting bar 12, i.e. the end located at the end wall 20 of the printing cylinder, a linkage 19 is arranged to connect the front fastening profile 6 to the rear fastening profile 7. The linkage is housed in a recess 49 in the bottom of the duct 11 in the case where the base plate 38 bears against the duct bottom, cf. FIG. 9, or in the space between the base plate 38 and the bottom of the duct 11 in the case where the base plate 38 is mounted at a distance from the duct bottom, cf. FIGS. 6-8.

The linkage 19 comprises a first block 27, which is fixedly attached to the underside of the adjusting bar 12 and has a groove 16 extending through it along its edge portion, see FIG. 6. A second block 28 is fixedly attached, in a corresponding manner, to the underside of the rear fastening profile 7 and has a groove 21 extending through it along its underside. Preferably, the grooves 16 and 21 are located in the same plane, as shown in FIG. 6. Finally, the linkage comprises an arm 24, which bears against the bottom of the duct 11 and the recess 49, respectively, see FIG. 9. The arm 24 is pivoted on a pivot 22, which is attached to the printing cylinder 5 and projects into a bore 50 in the arm. A first guide pin 25 projects from one end of the arm into the groove 16 in the first block 27 and a second guide pin 26 projects from the other end of the arm into the groove 21 in the second block 28, see. FIG. 6. FIG. 5 illustrates an alternative embodiment of the linkage 19. This too comprises an arm 24, which is pivoted on a pivot 22 attached to the printing cylinder 5 or the base plate 38. A first guide pin 25′ is attached to the adjusting bar 12 and projects towards the bottom of the duct 11 and engages an elongate, through opening 16′ at one end of the arm. A second guide pin 26′ is attached to the second fastening profile 7 and projects towards the duct bottom and engages an elongate through opening 21′ at the other end of the arm 24.

The above embodiments of the linkage work in the same way, as will be described below.

Reference is now made to FIGS. 8 and 10 for a more detailed description of the rear fastening profile 7, which is arranged to move parallel to the edges of the duct 11 towards and away from the front fastening profile 6 and which, preferably, has a convex or cambered edge 44 (see FIG. 11), which is oriented towards the front fastening profile 6. A number of parallel, T-shaped profiles 37 are attached to the bottom side (facing the duct 11 bottom) of the rear fastening profile 7, perpendicular to the fastening profile. The T-shaped profiles 37 are received, with a play, in T-shaped grooves 45 in the base plate 38 to retain the rear fastening profile 7 in the duct 11. Thus, the fastening profile can be moved back and forth, substantially parallel to the grooves 45 in the base plate. It can also be moved a certain distance back and forth in its longitudinal direction owing to the lateral play between the T-shaped grooves 45 and the T-shaped profiles 37, as is clearly illustrated in FIG. 10.

The front fastening profile 6 is held in place in a movable manner by means of holding members 51 (not shown in detail), see FIG. 7.

The angular adjustment of the printing plate mount 4 will be described in greater detail below, reference being made to FIGS. 11-13.

FIG. 11 shows the normal (and starting) position, in which there is no angular adjustment of the printing plate mount.

In FIG. 12, the adjusting bar 12 has been moved to the left in the figure by means of the screw mechanism 48, which is actuated using the knob 17, see FIG. 9. In this process, the guide pins 14 have been moved to the left along the shoulders 15, thereby causing the front fastening profile 6 to pivot in clockwise direction about the centre pin 36. This pivoting movement has been transmitted, through the first guide pin 25 or 25′, to the arm 24, which is pivoted in counter-clockwise direction about the pivot 22. The arm has thus caused the second guide pin 26 or 26′ to be moved closer to the end wall 20 of the printing cylinder and, by its engagement with the groove 21 or the opening 21′, to bring about a movement to the right of the rear fastening profile, as is clearly illustrated in FIG. 12.

To angularly adjust the printing plate mount 4 to the other side opposite that of FIG. 12, the adjusting bar 12 is moved to the right, as shown in FIG. 13, and through the above mechanisms the rear fastening profile is then moved to the left.

The above displacements of the rear fastening profile 7 ensure a lateral displacement of the rear edge of the printing plate mount 4, since one of its attachment strips 3, which is located at the rear edge, is attached to the rear fastening profile. Such a lateral displacement is a prerequisite to achieving the angular adjustment 10 and a direct geometric consequence of the angle of the leading edge of the printing plate mount being altered. The rear edge of the printing plate mount 4 is thus moved proportionally to the angular adjustment of the front fastening profile in accordance with the given geometry (the distance between the pivot 22 and respectively the guide pin 25, 25′ and the guide pin 26, 26′.

Reference is now made to FIGS. 16 and 17, which illustrate the mechanism for tensioning the printing plate mount on the printing cylinder.

Devices for tensioning the printing plate mount 4 on the outer surface of the printing cylinder are disposed on the end walls 18 and 20 of the printing cylinder. The tensioning serves to ensure that the printing plate mount is secured to the printing cylinder and tensioned by a more or less identified force and that it cannot come loose or move on the printing cylinder during the printing process. To ensure that the tensioning is evenly distributed with the same tensioning force over the whole width of the printing cylinder, the rear fastening profile 7 has a cambered shape. The camber is calculated so as to compensate for the bending of the rear profile when subjected to the load of the printing plate mount.

The printing plate mount 4 is mounted on the printing cylinder 5 by hooking its attachment strips 3 onto the front fastening profile 6 and the rear fastening profile 7. To secure the printing plate mount 4 to the printing cylinder 5, the mount 4 is firmly and tightly tensioned against the outer surface of the printing cylinder 5, which also prevents the attachment strips 3 from unhooking from the fastening profiles 6 and 7. The tensioning is achieved by radial parallel displacement of the rear fastening profile 7.

A tensioning mechanism of the same design is disposed on each of the end walls 18 and 20 of the printing cylinder 5. The mechanism has the following characteristics. A tensioning arm 32 is pivotally mounted on the shaft journal 31 of the printing cylinder 5. A piston rod of the air cylinder 29 is connected to a pin 33, which in turn is mounted on one end of the tensioning arm 32. The air cylinder 29 is mounted on the end wall 18 and 20, respectively, of the printing cylinder 5. When tensioning the printing plate mount 4, this is tensioned by a spring 40 pushing on said end of the tensioning arm 32, which pivots about the shaft journal 31, thereby causing the other end of the tensioning arm to pivot about the shaft journal, as is clearly illustrated in FIG. 17. The other end has a fork-shaped portion 43, into which extends a driving pin 34 projecting from the short side of the rear fastening profile 7 and in the longitudinal direction 9 of the printing cylinder. Thus, the other end of the tensioning arm 32 moves, by means of the fork-shaped portion 43 and the driving pin 34, the rear fastening profile 7 towards the front fastening profile 6 for tensioning of the printing plate mount 4 on the printing cylinder 5. When releasing the tensioning of the printing plate mount 4, the air cylinder 29 is activated and counteracts the tensioning force by means of a force that is greater than the pre-stressing force of the spring 40.

When releasing the tensioning of the printing plate mount 4 in connection with angular adjustment or removal of the printing plate mount, the rear profile 7 is moved in parallel in the direction opposite to the tensioning direction. This is achieved in a corresponding manner by actuating the tensioning arms 32 located on both end walls of the printing cylinder 5.

If the adequately adapted printing plate mount 4 is accurately mounted, the full force of the spring 40 acting on each end wall of the printing cylinder 5 will ensure a satisfactory tensioning.

When angularly adjusting the printing plate mount on the printing cylinder, the tensioning load on the printing plate mount is relieved by means of a push button, which activates a pneumatic back pressure counteracting the spring pressure applied for tensioning of the printing plate mount. This is necessary in order to reduce the friction between the outer surface of the printing cylinder and the printing plate mount. This is a prerequisite to ensuring the angular adjustment. When the angular adjustment of the printing plate mount is completed, the mount is re-attached to the printing cylinder.

As described above, the printing plate mount 4 is attached to the printing cylinder 5 by hooking one of its attachment strips 3 onto the front fastening profile 6, winding the printing plate mount around the outer surface of the printing cylinder and hooking its other attachment strip 3 onto the rear fastening profile and, then, by bringing the fastening profiles 6, 7 towards one another by means of the two tensioning arms 32. To fix the printing plate mount 4 in a certain position, it has been provided with a fixing hole 46 located close to one of its attachment strips 3, see FIG. 1. Furthermore, the centre pin 36 (see FIGS. 3 and 8) has been extended, so that it projects slightly beyond the upper surface of the front fastening profile 6 and can be inserted in the fixing hole 46. Said position corresponds to a reference line used when mounting the individual printing plates 1. This reference line and a further reference line corresponding to the leading edge of the printing plate mount 4, when mounted on the printing cylinder 5, form references when mounting the printing plates 1 on the printing plate mount 4. By coordinating the mounting of the individual printing plates 1 on the printing plate mount 4 and the attachment of the printing plate mount to the printing cylinder 5, it is ensured that the printed image on the corrugated board sheet or other material to be printed is accurately positioned from the start and that only minor fine adjustments to the position of the printed image may have to be made. This is an important principle, which greatly contributes to reducing the machine set-up times. The extension and dimensions of the centre pin 36 are adapted to fit the hole in the printing plate mount without protruding from the printing plate mount. In this way, it cannot be coloured by the application of ink from the printing machine.

The extension of the centre pin 36 has a further function, which is directly related to the device according to the invention.

When angularly adjusting the printing plate mount 4 on the printing cylinder 5, the extension of the centre pin also serves to hold the printing plate mount to prevent it from sliding sideways along the front fastening profile 6. By moving the rear fastening profile 7 sideways, the lateral movement will be transmitted to the printing plate mount and, in this way, the undesired movement will occur, if the centre pin 36 did not exist to lock the leading edge of the printing plate mount 4.

It is important that the rear edge of the printing plate mount 4 follow the lateral movement of the rear fastening profile 7 during the angular adjustment of the printing plate mount 4 on the printing cylinder 5. If this is not the case, then manual operations will be necessary to ensure that the rear edge is returned to an accurate lateral position in the rear fastening profile 7. This can be achieved by different methods of fixing the printing plate mount in the lateral direction in the rear profile. For example, fixing pins similar to the extension of the centre pin 36 may be used. A drawback of such a solution, however, is that it might be difficult to achieve a satisfactory degree of accuracy between the two holes in the printing plate mount for the extension of the centre line 36 and the fixing pin in the rear fastening profile 7. Considering the size of the printing plate mount 4 combined with the fact that it will be wound around the printing cylinder 5, this may turn out to be a complicated solution.

An alternative solution, therefore, is to fix the trailing edge of the printing plate mount by means of vacuum during the actual angular adjustment. Conveniently, this is achieved by means of a number of vacuum nozzles suitably positioned in the rear fastening profile.

Instead of vacuum, a currently preferred solution involves using one or more magnets 41, which are recessed in the upper side of the rear fastening profile. Preferably, permanent magnets are used, but also electromagnets may be used. A number of evenly distributed magnets 41 are recessed along the upper side of the rear fastening profile 7. Thin metal plates 42 of matching size are glued to the back of the mounting foil 2. The plates are positioned such that when attaching the printing plate mount 4 to the printing cylinder 5, they will be located opposite the recessed magnets on the rear fastening profile 7. When the printing plate mount 4 is arranged on the printing cylinder 5 and an angular adjustment is to be carried out, the magnets will retain the rear edge of the printing plate mount on the rear fastening profile 7. Thus, during the lateral movement of the rear profile, the rear edge of the printing plate mount will follow the lateral movement in a desirable manner. The magnets prevent the rear edge of the printing plate mount from sliding in the lateral direction on the rear fastening profile 7, which could otherwise easily occur due to the force inherent in the friction between the mounting foil 2 and the outer surface of the printing cylinder.

In addition, the use of magnets 41 on the fastening profile 7 serves another important function. The magnets will simplify the work of the machine operator when attaching the printing plate mount 4 to the printing cylinder 5 and removing it therefrom. To ensure that the attachments strips 3 will be correctly positioned in the grooves of the fastening profiles, it is necessary to carefully verify the position of the attachment strip 3 in the fastening profile 7, and, if needed, manually guide it into the correct position. The magnet 41 will retain the rear edge of the printing plate mount 4 in a correct position relative to the rear fastening profile 7 by means of the metal plates 42 attached to the mounting foil 2, which ensures adequate tensioning and locking of the printing plate mount 4 on the printing cylinder 5 without any manual operations for holding the printing plate mount in the correct position. This reduces the risk of injuries, facilitates the attachment of the printing plate mount in the machine and, above all, helps reduce the machine set-up times.

A corresponding set of magnets may, of course, be recessed in the upper side of the front fastening profile 6. These magnets are combined, in a similar manner, with metal plates 42 arranged on the mounting foil 2. The intention is not to replace the centre pin 36 extension. Instead this device is retained, since it is needed to provide a distinct and exact reference for the positioning of the printing plate mount on the printing cylinder. The function of the magnets disposed on the front profile will be the same as that of the ones on the rear profile, namely to facilitate attachment and reduce the need for manual operations.

To provide the mounting foil 2 with a number of thin metal plates 42 arranged according to a certain pattern is a preparatory operation that reduces the manual operations inside the machine. Accordingly, the preparatory operation is carried out outside the machine, which means that valuable machine time can be reduced and that the machine is thus available for production during the time saved due to reduced set-up times.

The magnets and the metal plates may, for example, be provided with a roughed surface to increase the friction and obtain improved adherence of the printing plate mount 4 to the rear fastening profile 7. In this way, the risk of undesirable lateral movement between the fastening profile 7 and the printing plate mount 4 in connection with angular adjustments is reduced. Alternatively, or as a complement, one or both fastening profiles 6, 7 have friction-enhancing means 52, such as a coating or a thin textured surface, on their upper side to increase the friction against the back of the printing plate mount.

Primarily, the device according to the invention is to be used in corrugated board in-line machines, but also includes other conceivable fields of use, such as other machines with printing units for printing on various materials, solid fibreboard, paper, cardboard etc.

The invention is not limited to that stated above and illustrated in the drawings, but can be modified within the scope of the claims.

1. A device for tensioning and angularly adjusting a printing plate mount on a rotary printing cylinder having a duct, which is formed in the longitudinal direction of the printing cylinder and in the outer surface thereof and in which the device is mounted, the device comprising a base plate on which a pair of fastening profiles for holding the printing plate mount are movably arranged, a pair of guide pins engaging a pair of shoulders for angularly adjusting one fastening profile when moving the guide pins or the shoulders in the longitudinal direction of the printing cylinder, the two fastening profiles being connected to one another, wherein the base plate is fixedly attached in the duct and has a groove, which extends in the longitudinal direction of the printing cylinder and in which an adjusting bar that supports the guide pins or shoulders is movably carried, that the front fastening profile is pivoted on a centre pin, which is fixedly attached to the base plate, and comprises said shoulders or guide pins, that the rear fastening profile is movably carried on the base plate, substantially in the direction of rotation of the printing cylinder and that the fastening profiles are connected to one another by a linkage at one end wall of the printing cylinder.

2. A device according to claim 1 wherein the linkage comprises an arm that is pivoted on a pivot attached to the printing cylinder or the base plate, that the arm at one end supports a first guide pin engaging a groove associated with the adjusting bar and that the arm at its other end supports a second guide pin engaging a groove in a block attached to said rear fastening profile.

3. A device according to claim 1 wherein the linkage comprises an arm which is pivoted on a pivot attached to the printing cylinder or the base plate, that a first guide pin is attached to the adjusting bar and projects towards the bottom of the duct and engages an opening at one end of the arm and that a second guide pin is attached to said rear fastening profile and projects towards the bottom of the duct and engages an opening at the other end of the arm.

4. A device according to claim 1, wherein a tensioning mechanism is arranged on each end wall of the printing cylinder, comprising a tensioning arm which is pivoted on the shaft journal of the printing cylinder, a pressure fluid cylinder and a spring unit which are attached to the respective end walls and connected to one end of the tensioning arm, and a fork-shaped portion at the other end of the tensioning arm, which fork-shaped portion surrounds a driving pin projecting from the short side of the rear fastening profile, in the longitudinal direction of the printing cylinder, whereby the rear fastening profile is movable towards and away from the front fastening profile.

5. A device according to claim 1, wherein the rear fastening profile has a convex edge, which is oriented towards the front fastening profile.

6. A device according to claim 1, wherein a number of parallel, T-shaped grooves are formed in the base plate and extend perpendicular to the longitudinal direction of the printing cylinder, that a T-shaped mounting profile is movably carried, with a lateral clearance, in each T-shaped groove and that said mounting profiles are fixedly attached to the rear fastening profile, whereby the rear fastening profile can be moved substantially perpendicular towards and away from the front fastening profile and a certain distance in the longitudinal direction.

7. A device according to claim 1, wherein the centre pin projects from the upper side of the fastening profile and is adapted, when mounting the printing plate mount, to be inserted in a hole therein for fixing the printing plate mount to the first fastening profile.

8. A device according to claim 1, wherein the second fastening profile, and, if needed, also the first fastening profile, supports one or more magnetic means in its longitudinal direction, said magnetic means cooperating with metal plates or strips attached to the printing plate mount for fixing the printing plate mount to the second fastening profile and, if applicable, also to the first fastening profile.

9. A device according to claim 8, wherein the magnetic means comprises one or more electromagnets.

10. A device according to claim 1, wherein one or both of the fastening profiles have a friction-enhancing means disposed on their upper face to increase the friction against the back of the printing plate mount.
